(19) United States
(12) Patent Application Publication
(10) Pub. No.: US 2017/0073496 A1
(43) Pub. Date: Mar. 16, 2017

(54) POLYAMIDE RESINS WITH MINERAL ADDITIVES

(71) Applicant: INVISTA NORTH AMERICA S.A R.L., Wilmington, DE (US)

(72) Inventor: John F. BUZINKAI, Chattanooga, TN (US)

(73) Assignee: INVISTA NORTH AMERICA S.A R.L., WILMINGTON, DE (US)

(21) Appl. No.: 15/123,922

(22) PCT Filed: Mar. 6, 2015
(86) PCT No.: PCT/US2015/019277

§ 371 Date: Sep. 6, 2016

Related U.S. Application Data
(60) Provisional application No. 61/949,487, filed on Mar. 7, 2014.

(51) Int. Cl. C08K 3/34

(52) U.S. Cl. CPC C08K 3/34

(57) ABSTRACT

Polyamide resins with mineral additives which accelerate crystallization without adversely affecting mechanical properties of articles molded therefrom, methods for their production and articles of manufacture prepared from these polyamide resins are provided.

### CROSS-REFERENCE TO RELATED APPLICATIONS

This application claims the priority filing date of U.S. Provisional application Ser. No. 61/949,487, filed Mar. 7, 2014, the disclosures of which are specifically incorporated herein by reference in its entirety.

### FIELD OF INVENTION

The present invention relates to polyamide resins with mineral additives which accelerate crystallization without adversely affecting mechanical properties of articles molded therefrom. The present invention also relates to methods for accelerating crystallization of polyamide resins and articles of manufacture prepared from these polyamide resins.

### BACKGROUND OF THE INVENTION

Unreinforced lubricated PA66 resins are used in many injection molding processes to form various molded parts, including cable ties. In order to decrease the time required for solidification during an injection molding cycle, some commercial grades of unreinforced lubricated PA66 have incorporated additives which accelerate the crystallization rate; such additives are referred to as nucleants.

Nucleants for PA66 polymer are disclosed in U.S. Pat. No. 3,755,221, U.S. Pat. No. 4,176,227, U.S. Pat. No. 4,200,707, U.S. Pat. No. 4,237,034, U.S. Pat. No. 4,866,115, and U.S. Pat. No. 6,197,855. However, nucleant additives can result in more brittle behavior in the molded parts. Thus, there is a need for nucleants which do not cause brittleness in resins when used for molded parts.

### SUMMARY OF THE INVENTION

There is provided a polyamide resin comprising a polyamide and a mineral additive which accelerates the crystallization rate of the resin without inducing brittleness to the resin. The polyamide resin may contain additional reinforcing materials. The polyamide of the polyamide resin may comprise a nylon such as polyamide 6,6 (PA66) and a mineral additive which further comprises wollastonite. The mineral additive can be present in amounts as low as less than 1% of the weight of the polyamide resin.

Another aspect of the present invention relates to a method for accelerating crystallization rate of a polyamide when cooled from a molten state, said method comprising adding to a polyamide resin a mineral additive.

There is also provided an article of manufacture, at least a portion of which is molded from a polyamide resin comprising a polyamide and a mineral additive. The article of manufacture can be formed of the polyamide resin and if desired include reinforcing materials.

### DETAILED DESCRIPTION OF THE INVENTION

Wollastonite is a naturally occurring mineral of composition calcium silicate. It has now been found that addition of a mineral such as wollastonite to a polyamide resin accelerates the rate of crystallization of the polyamide when it is cooled from the molten state. Further, unlike other nucleants, addition of the mineral does not adversely affect mechanical properties of articles molded from this resin. Accordingly, the present invention relates to polyamide resins with an accelerated rate of crystallization comprising a polyamide and a mineral additive.

Examples of polyamides which can be used in the resins of the present invention include, but are not limited to, PA66, PA6, PA66/6, PA6/66, PA46, PA612, PA12, PA610, PA6I/6T, PA6I, PA9T, PADT, PAD6 (D=2-methyl-1,5-diaminopentane), and PA7, and/or combinations thereof, including copolymers. In one embodiment, the polyamide is PA66. The polyamide may contain other reinforcing materials (e.g., glass fibers, or mineral powders at less than 1 percent by weight, however such reinforcing materials are not required and may not be desired depending upon the intended use for the resin.

Examples of mineral additives which can be used in the resins of the present invention include, but are not limited to, mineral compositions of calcium silicate such as wollastonite. In one embodiment, the mineral additive is a wollastonite mineral powder. In one embodiment, the wollastonite mineral powder is added at less than 1% by weight to the polyamide resin. The grade of wollastonite mineral is preferred to be finely ground, with a silane applied as surface treatment. This allows very good dispersion of the wollastonite powder into the polyamide resin, without having agglomerates or oversized particles that may cause loss of mechanical strength in molded parts.

In one embodiment, the wollastonite mineral powder has a particle size under 20 microns. In another embodiment, the wollastonite mineral powder has a particle size under 15 microns. In yet another embodiment, the wollastonite mineral powder has a particle size less than 10 microns, and specifically it is preferred that D90 is less than 10 microns as measured by Cilas Granulometer instrument or similar instrument. It is industrially known that D90 is the equivalent diameter of particle size at which 90 wt % of the powder is equal or smaller than that size.

Tests were performed showing wollastonite mineral at 0.2 or 0.5% by weight in PA66 (unreinforced, lubricated with less than 0.6% by weight total of internal and external lubricant additives) gives much faster crystallization, while maintaining excellent mechanical properties in molded specimens. This contrasts with many other mineral powders which were tested and show either brittleness in mechanical properties or only weak nucleation of crystallization. More specifically, it was found that addition of wollastonite mineral to unreinforced lubricated PA66 provided a resin, exhibiting fast crystallization and very good mechanical properties in molded parts.

### Test and Analytical Methods

Differential Scanning Calorimetry (DSC)—Sample characterization was performed using single-cell, Differential Scanning Calorimetry (DSC). The DSC instrument was calibrated per ISO 11357 requirements. The DSC program to evaluate crystallization rates of the test samples involves heating and cooling cycles. Each test sample was first equilibrated at 25° C. for several minutes. The equilibrated sample temperature was then increased at about 20.0° C./min rate to the target temperature of 290° C. The sample was maintained at the target temperature for three minutes. The sample was then cooled to 50° C. at 50° C./min rate, and the test was completed. The temperature corresponding to the peak in the crystallization exotherm is the Crystallization Peak Temperature.

Pendulum Impact Test—These tests are performed on an instrument calibrated per ISO 13802. Notched Charpy impact testing was done per method ISO 179-1/1eA. Notched Izod impact testing was done per method ISO 180/A.

Tensile Test—These tests are done per method ISO 527 on Type 1A test specimens. Crosshead speed is 50 mm/min. Nominal break strain was calculated based on crosshead position.

### EXAMPLES

Preparation of Specimens—Molded specimens were prepared from PA66 resins by a typical injection molding process on a 1000 kiloNewton (kN) Arburg Injection Molding Machine.

The control PA66 polymer resin, as used herein, refers to INVISTA TORZEN® U4820L PA66 resin. This PA66 polymer is unreinforced and lubricated polymer resin. A technical datasheet is available at the website—http://ep.invista.com/en/index.html

### Example 1 (Control)

Test pellets and molded bar specimens were prepared from the control PA66 resin. The DSC, pendulum impact test and tensile test, described above, were then performed on the pellet and molded bar specimens.

### Example 2

In this example, a preparation process for the resin first prepared a concentrate of NYCO® Minerals M9992 wollastonite at 15 wt % loading in PA66 feedstock polymer by a twin-screw compounding process. These compounded wollastonite pellets were then combined with PA66 polymer in a molten state, the combination was mixed to disperse the wollastonite pellets through the polymer, and then formed into pellets. The final loading of wollastonite mineral powder in the polyamide resin is less than 1 wt %, preferably about 0.2 to 0.5 wt %. Other additives present in PA66 resin include up to 0.3% stearyl erucamide as lubricant, up to 0.3% aluminum stearate as lubricant, and 10 to 300 ppm sodium hypophosphite.

Test pellets and molded bar specimens were prepared from the wollastonite polyamide resin. The DSC, pendulum impact test and tensile test, described above, were performed on the pellet and molded bar specimens.

### Example 3

Concentrate pellets of 5 wt % talc powder in PA66 (prepared by a typical twin-screw compounding process) were combined with PA66 polymer in a molten state, mixed to disperse, and then formed into pellets. The final loading of talc mineral powder in this resin was 200 ppm. Other additives present were stearyl erucamide lubricant at less than 0.3 wt %, and aluminum stearate lubricant at less than 0.3 wt %, and 10 to 300 ppm sodium hypophosphite. Test pellets and molded bar specimens are prepared from this resin. The DSC, pendulum impact test and tensile test, described above, were performed on the pellet and molded bar specimens of this example. The resin of this example exhibited increased brittleness.

Data for pellets and molded specimens, prepared from the individual resins described in Examples 1-3, are shown in the following Table 1.

TABLE 1

| | | Crystallization Peak | | | | | |
|---|---|---|---|---|---|---|---|
| | | Temperature (Deg. C.) | | | | | |
| | | | for | Notched | Notched | Tensile | Tensile |
| Example | | | molded | Charpy, | Izod, | Strength | Break |
| No. | Resin | for pellet | bar | kJ/m² | kJ/m² | MPa | Strain |
| 1 | Polyamide resin (Control) | 208.1 | 214.2 | 4.4 | 4.9 | 80.1 | 22% |
| 2 | PA66 + wollastonite | 220.4 | 222.6 | 4.2 | 4.7 | 82.9 | 25% |
| 3 | PA66 + 200 ppm talc | 223.5 | 226.9 | 2.1 | 3.7 | 91.4 | 11% |
| | (Brittle properties) | | | | | | |

Crystallization peak temperatures were measured by a DSC method. Results show much faster crystallization in NPD-048 versus standard TORZEN® U4820L resin. This is demonstrated by the peak of crystallization exotherm occurring at a higher temperature for NPD-048 (about 12° C. higher in comparing pellet samples, about 8° C. higher in comparing molded specimens). However, mechanical properties of specimens from NPD-048 are equivalent to those from TORZEN® U4820L resin. In contrast, while PA66 resin containing 200 ppm talc as a nucleant additive shows very fast crystallization, it also shows some brittleness in mechanical properties. This is fairly typical for nucleated resins.

### Examples 4 (A-D)

In these examples, a process to make a resin formulation, which provides accelerated crystallization rate in molded objects, is to prepare a pellet blend of wollastonite concentrate pellets with PA66 resin pellets, feed this pellet blend to an injection molding machine, and form molded parts. Data for molded bar specimens from such a process are shown in Table 2 as Examples 4 (A-D) along with comparative results.

TABLE 2

| | | Crystallization | | | | |
|---|---|---|---|---|---|---|
| | | Peak | Notched | Notched | | |
| | | Temperature | Charpy | Charpy | Tensile | Tensile |
| | | (Deg. C.) for | at 23° C., | at −30° C., | Strength | Break |
| Example No. | Pellet Blend | molded bar | kJ/m² | kJ/m² | MPa | Strain |
| 4 (A) | TORZEN ® U4820L | 214 | 4.3 | 2.3 | 80 | 19% |
| Comparative | | | | | | |
| 4 (B) | TORZEN ® U4820L + | 221 | 4.6 | 4.2 | 83 | 31% |
| | 0.2 wt % woilastonite | | | | | |
| | (from 15 wt % concentrate) | | | | | |
| 4 (C) | TORZEN ® U4820L + | 221 | 4.2 | 3.6 | 83 | 34% |
| | 0.4 wt % wollastonite | | | | | |
| | (from 15 wt % concentrate) | | | | | |
| 4 (D) | TORZEN ® U4820L + | 227 | 2.6 | 2.3 | 91 | 20% |
| Comparative | 0.05% talc | | | | | |
| | (from 5% concentrate) | | | | | |

Accordingly, the present invention also provides methods for accelerating crystallization rate of a polyamide when cooled from a molten state by adding to a polyamide resin a mineral additive. Thus, reducing cycle time for injection molded parts.

In addition, the present invention provides articles of manufacture, at least a portion of which is molded from a polyamide resin comprising a polyamide and a mineral additive in accordance with the present invention. The resin is typically poured or filled into t molding die and then subjected to pressing and heating conditions for a period of time suitable to form the desired article. The molded resin is then removed from the molding die after being first cooled down to a desired surface temperature required to stabilize the shape of the article.

The present invention is further illustrated by the above examples. It is to be understood that the examples are for illustration purposes only and are not used to limit the present invention thereto.

What is claimed:

1. A resin comprising a polyamide and a mineral additive which increases the rate of crystallization of the resin.

2. The polyamide resin of claim 1 wherein the polyamide resin contains no additional reinforcing materials.

3. The polyamide resin of claim 1 wherein the polyamide is PA66.

4. The polyamide resin of claim 1 wherein the mineral additive comprises wollastonite.

5. The polyamide resin of claim 1 wherein the mineral additive comprises a wollastonite mineral powder.

6. The polyamide resin of claim 1 wherein the wollastonite mineral powder is added at less than 1 wt % to the polyamide resin.

7. A method for accelerating crystallization rate of a polyamide when cooled from a molten state, said method comprising adding to a polyamide resin a mineral additive.

8. The method of claim 7 wherein the polyamide resin contains no additional reinforcing materials.

9. The method of claim 7 wherein the polyamide is PA66.

10. The method of claim 7 wherein the mineral additive comprises wollastonite.

11. The method of claim 7 wherein the mineral additive comprises a wollastonite mineral powder.

12. The method of claim 7 wherein the wollastonite mineral powder is added at less than 1 wt % to the polyamide resin.

13. The resin of claim 1 wherein at least a portion of the resin is molded into the form of an article or at least a portion of an article.
